(19) United States
(12) Patent Application Publication
(10) Pub. No.: US 2026/0135429 A1
(43) Pub. Date: May 14, 2026

(54) CORELESS MOTOR

(71) Applicant: AAC Microtech (Changzhou) Co., Ltd., Changzhou City (CN)

(72) Inventors: Jinguo Wu, Changzhou (CN); Sensen Yang, Changzhou (CN); Feng Yan, Changzhou (CN); Junsheng Wang, Changzhou (CN)

(21) Appl. No.: 19/036,039

(22) Filed: Jan. 24, 2025

Related U.S. Application Data
(63) Continuation of application No. PCT/CN2024/131602, filed on Nov. 12, 2024.

(51) Int. Cl. H02K 5/04; H02K 1/30; H02K 7/08; H02K 11/215; H02K 21/14

(52) U.S. Cl. CPC H02K 5/04; H02K 1/30; H02K 7/083; H02K 11/215; H02K 21/14; H02K 2211/03

(57) ABSTRACT

The present disclosure discloses a coreless motor including an outer housing, a first lid mounted on the outer housing, an inner housing with a second receiving space, received in the first receiving space, a rotor rotatably connected to the first lid and the inner housing, and a stator coil received in the second receiving space and fixed to inner housing; the outer housing includes an end portion enclosed an opening; the first lid includes a fixation portion mounted on the end portion and a first extending portion extending into the opening; the first extending portion is fixed to the inner housing.

### FIELD OF THE PRESENT DISCLOSURE

The present disclosure relates to motor technologies, especially relates to a coreless motor.

### DESCRIPTION OF RELATED ART

Due to its compact structure, high power density, and energy saving, coreless motor has been widely applied in motor and generator.

In related art, the coreless motor includes an inner shell for receiving a rotor and a stator, and an outer shell receiving the inner shell for protecting the inner components. Generally, the inner shell is fixed to the outer shell by glue or compression molding for achieving anti-rotation function. However, owing to long period vibration, the glue bonding between the inner shell and the outer shell is prone to disabled thus reducing the reliability of the coreless motor. Besides, the two fixation manners have high requirements for size consistency of the components, and also nor prone to disassembly for reuse.

Therefore, it is necessary to provide an improved coreless motor to overcome the problems mentioned above.

### SUMMARY OF THE INVENTION

One object of the present disclosure is to provide a coreless motor easy to be assembled and higher anti-rotation performance.

The coreless motor includes an outer housing with a first receiving space; a first lid mounted on the outer housing; an inner housing with a second receiving space, received in the first receiving space, including: a second lid opposite to the first lid; and a shell sandwiched between the first lid and the second lid; a rotor rotatably connected to the first lid and the second lid, being rotatable about an axis of rotation; a stator coil received in the second receiving space and fixed to the shell, surrounding the rotor at an interval; wherein the outer housing includes an end portion enclosed an opening; the first lid includes a fixation portion mounted on the end portion and covering the opening, and a first extending portion extending into the opening; the first extending portion is fixed to the shell; the end portion comprises a plurality of first mounting holes; the fixation portion includes a plurality of second mounting holes penetrating thereon; each of the plurality of first mounting holes is arranged opposite to a corresponding one of the plurality of the second mounting holes; the first lid is fixed to the outer housing by inserting a fixation member into one of the plurality of first mounting holes and a corresponding one of the plurality of the second mounting holes.

As an improvement, the fixation portion includes an edge portion; the plurality of second mounting holes is provided on the edge portion.

As an improvement, the end portion includes a location slot depressed towards the second lid; the fixation portion includes a location protrusion protruding from the edge portion towards the second lid; the location protrusion is embedded into the location slot.

As an improvement, the shell includes a cylindrical side wall, and a fixation wall extending inwardly from one end of the side wall closer to the first lid; the first extending portion is fixed to the fixation wall.

As an improvement, the fixation wall includes a third mounting hole penetrating thereon; the first extending portion comprises a protrusion protruding towards the side wall; the protrusion is embedded into the third mounting hole.

As an improvement, the first lid further includes a second extending portion extending from the first extending portion towards the second lid; the fixation wall is annular; the second extending portion is positioned inside the fixation wall.

As an improvement, the rotor includes a shaft having two ends rotatably connected to the second lid and the second extending portion respectively, and a driving magnet sleeved on the shaft; the stator coil includes a stator coil mounted on the side wall.

As an improvement, further including a first bearing and a second bearing separately connected to two ends of the shaft; the second extending portion is annular; the first bearing is positioned inside the second extending portion; the second bearing is mounted on the second lid.

As an improvement, the second lid includes a main plate for mounting the second bearing, and a side plate extending from an edge of the main plate away from the first lid; a third receiving space is enclosed by the side plate; the shaft extends into the third receiving space.

As an improvement, further including a circuit board configured to electrically activate the stator coil; the circuit board is mounted on the side plate and spaced from the main plate.

As an improvement, further including a connector mounted on one side of the circuit board away from the side plate for electrically connecting the circuit board with an external circuit; the outer housing includes a through hole corresponding to the connector.

As an improvement, further including a detecting unit received in the third receiving space; the detecting unit includes a detect magnet sleeved on the shaft and a hall sensor opposite to the detect magnet; the hall sensor is mounted on one side of the circuit board away from the connector; the detect magnet is located closer to the circuit board than the second bearing.

As an improvement, the rotor further includes a magnetic loop member sleeved on the shaft; the driving magnet is sleeved on the magnetic loop member.

### BRIEF DESCRIPTION OF THE DRAWINGS

The present disclosure will hereinafter be described in detail with reference to an exemplary embodiment. To make the technical problems to be solved, technical solutions and beneficial effects of present disclosure more apparent, the present disclosure is described in further detail together with the figures and the embodiment. It should be understood the specific embodiment described hereby is only to explain this disclosure, not intended to limit this disclosure.

FIG. 1 is an isometric view of a coreless motor in accordance with an exemplary embodiment of the present disclosure.

FIG. 2 is an exploded view of the coreless motor in FIG. 1.

FIG. 3 is a cross-sectional view of the coreless motor taken along line A-A in FIG. 1.

FIG. 4 is an exploded view of part of the coreless motor in FIG. 1.

### DETAILED DESCRIPTION OF THE EXEMPLARY EMBODIMENT

The present disclosure will hereinafter be described in detail with reference to an exemplary embodiment. To make the technical problems to be solved, technical solutions and beneficial effects of the present disclosure more apparent, the present disclosure is described in further detail together with the figure and the embodiment. It should be understood the specific embodiment described hereby is only to explain the disclosure, not intended to limit the disclosure.

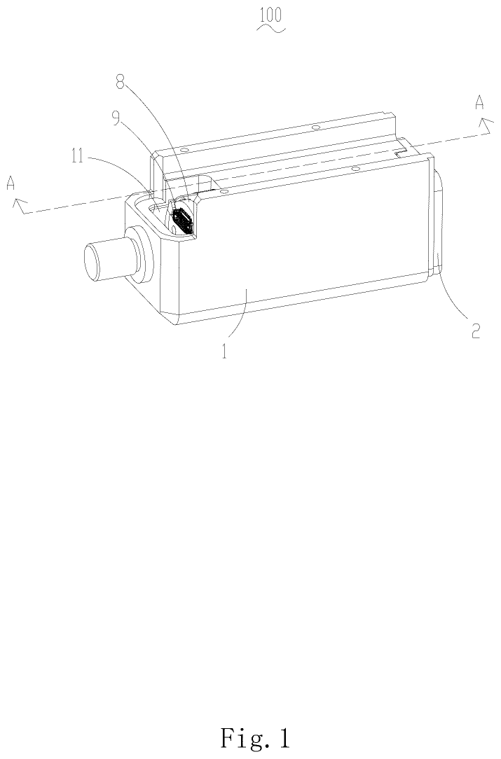

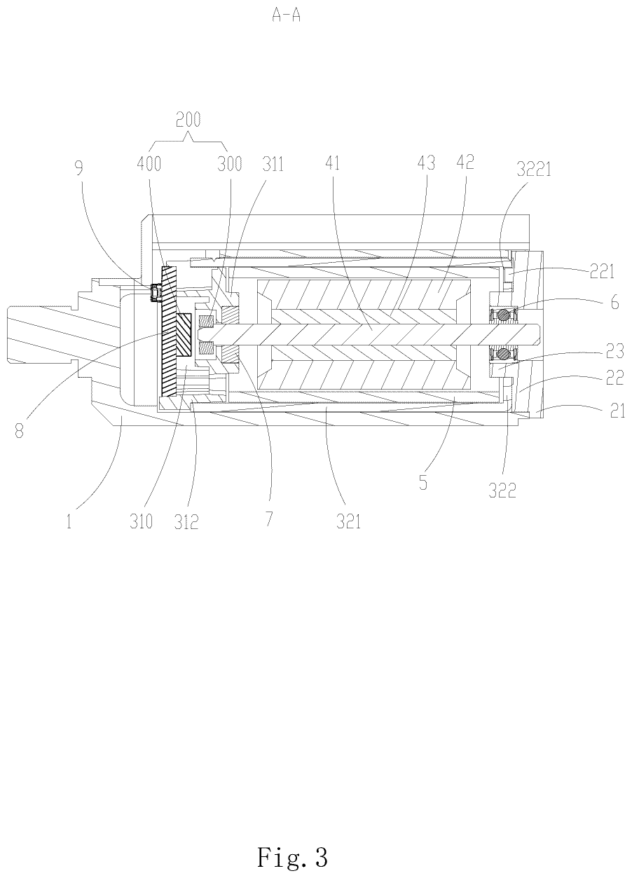

Please refer to FIGS. 1-4 together, a coreless motor 100 provided by an exemplary embodiment of the present disclosure includes an outer housing 1 with a first receiving space 10, a first lid 2 mounted on the outer housing 1, an inner housing 3 with a second receiving space 30 received in the first receiving space 10, a rotor 4 rotatably connected to the first lid 2 and the inner housing 3 and being rotatable about an axis of rotation, and a stator coil 5 fixed to inner housing 3 surrounding the rotor at an interval.

The stator coil 5 and the rotor 4 are both received in the second receiving space 30. The first receiving space 10 is enclosed by the outer housing 1 and the first cover plate 2 jointly.

Specifically, the inner housing 3 includes a second lid 31 opposite to the first lid 2, and a shell 32 sandwiched between the first lid 2 and the second lid 31. The rotor 4 is rotatably connected to the first lid 2 and the second lid 31. The inner housing 2, the rotor 4, and the stator coil 5 are all received in the first receiving space 10 of the outer housing 1.

Moreover, the outer housing 1 includes an end portion 11 enclosed an opening 12. The first lid 2 includes a fixation portion 21 mounted on the end portion 11 and covering the opening 12, and a first extending portion 22 extending into the opening 12. The first extending portion 22 is fixed to the shell 32. In this manner, the first lid 2 is fixed to the inner housing 3 and the outer housing 1 simultaneously, thus improving the anti-rotation performance of the coreless motor 100 when the rotor 4 is driven to rotate.

In addition, the end portion 11 includes a plurality of first mounting holes 111. The fixation portion 21 includes a plurality of second mounting holes 211 penetrating thereon. Each of the plurality of first mounting holes111 is arranged opposite to a corresponding one of the plurality of the second mounting holes 211. The first lid 2 is fixed to the outer housing 1 by inserting a fixation member into one of the plurality of first mounting holes 111 and a corresponding one of the plurality of the second mounting holes 211. The fixation member could be screw. Thus, the fixation stability between the first lid 2 and the outer housing 1 is highly improved. Besides, this assembly structure is prone to disassemble, thus being available for component reuse.

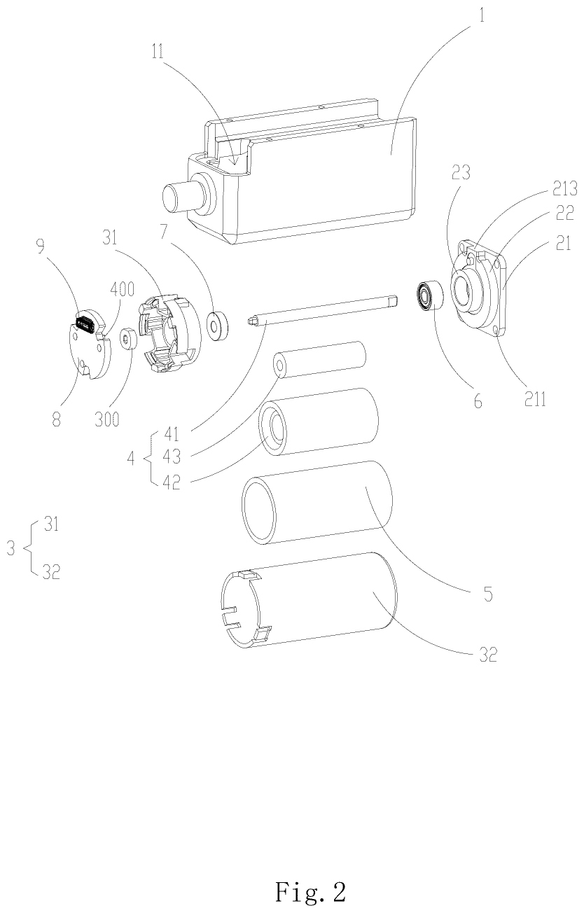

As shown in FIGS. 2-4, the fixation portion 21 comprises an edge portion 212. The plurality of second mounting holes 211 is provided on the edge portion 212.

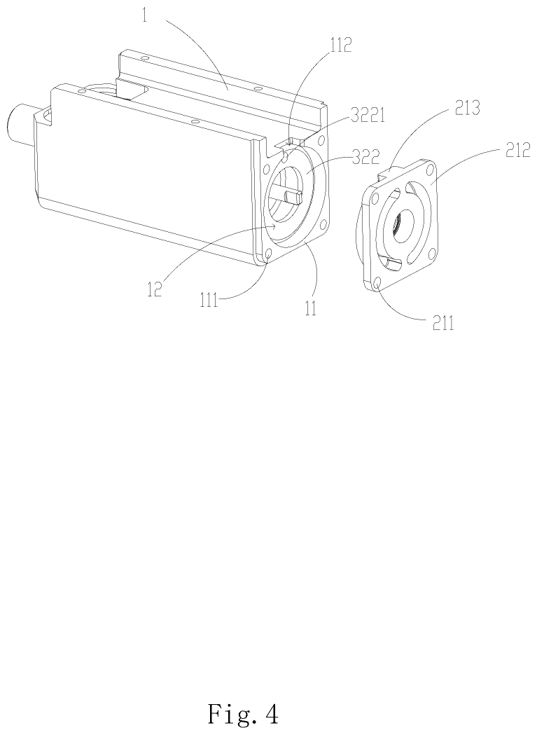

As shown in FIG. 2 and FIG. 4, the end portion 11 includes a location slot 112 depressed towards the second lid 31. The fixation portion 21 includes a location protrusion 213 protruding from the edge portion 212 towards the second lid 31. The location protrusion 213 is embedded into the location slot 112 for further improving the anti-rotation performance of the coreless motor 100. In one embodiment, the location protrusion 213 is connected to the first extending portion 22.

The shell 32 includes a cylindrical side wall 321, and a fixation wall 322 extending inwardly from one end of the side wall 321 closer to the first lid 2. The first extending portion 22 is fixed to the fixation wall 322. To be specific, the fixation wall 322 includes a third mounting hole 3221 penetrating thereon. The first extending portion 22 includes a protrusion 221 protruding towards the side wall 321. The protrusion 221 is embedded into the third mounting hole 3221.

The first lid 2 further includes a second extending portion 23 extending from the first extending portion 22 towards the second lid 31. The fixation wall 322 is annular. The second extending portion 23 is positioned inside the fixation wall 322.

The rotor 4 includes a shaft 41 having two ends rotatably connected to the second lid 31 and the second extending portion 23 respectively, and a driving magnet 42 sleeved on the shaft 41. The driving magnet 41 is spaced from the second lid 31 and the second extending portion 23.

The stator coil 5 is mounted on the side wall 321. The stator coil 5 is arranged to surround the driving magnet 42. For further improving the driving force between the stator coil 5 and the driving magnet 42, the rotor 4 further includes a magnetic loop member 43 sleeved on the shaft 41. The driving magnet 42 is sleeved on the magnetic loop member 43.

The coreless motor 100 further includes a first bearing 6 and a second bearing 7 separately connected to two ends of the shaft 41. The second extending portion 23 is annular. The first bearing 6 is positioned inside the second extending portion 23. The second bearing 7 is mounted on the second lid 31.

Specifically, the second lid 31 comprises a main plate 311 for mounting the second bearing 7, and a side plate 312 extending from an edge of the main plate 311 away from the first lid 2. A third receiving space 310 is enclosed by the side plate 312 with the main plate 311. The shaft 41 extends into the third receiving space 310.

Furthermore, the coreless motor 100 includes a circuit board 8 and a connector 9 configured to electrically activate the stator coil 5. The circuit board 8 is mounted on the side plate 312 and spaced from the main plate 311. The connector 9 is mounted on one side of the circuit board 8 away from the side plate 312 for electrically connecting the circuit board 8 with an external circuit. The outer housing 1 includes a through hole 11 corresponding to the connector 9.

Moreover, the coreless motor 100 further includes a detecting unit 200 received in the third receiving space 310. The detecting unit 200 includes a detect magnet 300 sleeved on the shaft 41 and a hall sensor 400 opposite to the detect magnet 300 and arranged at an interval. The hall sensor 400 is mounted on one side of the circuit board 8 away from the connector 9. The detect magnet 300 is located closer to the circuit board 8 than the second bearing 7. When the rotor 4 rotates, the detecting magnet 300 rotates along with the shaft 41. The rotation angle could be detected by the hall sensor 400.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A coreless motor comprising:
an outer housing with a first receiving space;
a first lid mounted on the outer housing;
an inner housing with a second receiving space, received in the first receiving space, comprising:
a second lid opposite to the first lid; and
a shell sandwiched between the first lid and the second lid;
a rotor rotatably connected to the first lid and the second lid, being rotatable about an axis of rotation;
a stator coil received in the second receiving space and fixed to the shell, surrounding the rotor at an interval; wherein
the outer housing includes an end portion enclosed an opening; the first lid includes a fixation portion mounted on the end portion and covering the opening, and a first extending portion extending into the opening; the first extending portion is fixed to the shell;
the end portion comprises a plurality of first mounting holes; the fixation portion comprises a plurality of second mounting holes penetrating thereon; each of the plurality of first mounting holes is arranged opposite to a corresponding one of the plurality of the second mounting holes; the first lid is fixed to the outer housing by inserting a fixation member into one of the plurality of first mounting holes and a corresponding one of the plurality of the second mounting holes.

2. The coreless motor as described in claim 1, wherein the fixation portion comprises an edge portion; the plurality of second mounting holes is provided on the edge portion.

3. The coreless motor as described in claim 2, wherein the end portion includes a location slot depressed towards the second lid; the fixation portion includes a location protrusion protruding from the edge portion towards the second lid; the location protrusion is embedded into the location slot.

4. The coreless motor as described in claim 1, wherein the shell comprises a cylindrical side wall, and a fixation wall extending inwardly from one end of the side wall closer to the first lid; the first extending portion is fixed to the fixation wall.

5. The coreless motor as described in claim 4, wherein the fixation wall comprises a third mounting hole penetrating thereon; the first extending portion comprises a protrusion protruding towards the side wall; the protrusion is embedded into the third mounting hole.

6. The coreless motor as described in claim 1, wherein the first lid further comprises a second extending portion extending from the first extending portion towards the second lid; the fixation wall is annular; the second extending portion is positioned inside the fixation wall.

7. The coreless motor as described in claim 6, wherein the rotor comprises a shaft having two ends rotatably connected to the second lid and the second extending portion respectively, and a driving magnet sleeved on the shaft; the stator coil comprises a stator coil mounted on the side wall.

8. The coreless motor as described in claim 7, further comprising a first bearing and a second bearing separately connected to two ends of the shaft; the second extending portion is annular; the first bearing is positioned inside the second extending portion; the second bearing is mounted on the second lid.

9. The coreless motor as described in claim 8, the second lid comprises a main plate for mounting the second bearing, and a side plate extending from an edge of the main plate away from the first lid; a third receiving space is enclosed by the side plate; the shaft extends into the third receiving space.

10. The coreless motor as described in claim 9, further comprising a circuit board configured to electrically activate the stator coil; the circuit board is mounted on the side plate and spaced from the main plate.

11. The coreless motor as described in claim 10, further comprising a connector mounted on one side of the circuit board away from the side plate for electrically connecting the circuit board with an external circuit; the outer housing comprises a through hole corresponding to the connector.

12. The coreless motor as described in claim 10, further comprising a detecting unit received in the third receiving space; the detecting unit includes a detect magnet sleeved on the shaft and a hall sensor opposite to the detect magnet; the hall sensor is mounted on one side of the circuit board away from the connector; the detect magnet is located closer to the circuit board than the second bearing.

13. The coreless motor as described in claim 7, wherein the rotor further comprises a magnetic loop member sleeved on the shaft; the driving magnet is sleeved on the magnetic loop member.
